(19) United States
(12) Patent Application Publication
(10) Pub. No.: US 2005/0213210 A1
(43) Pub. Date: Sep. 29, 2005

(54) Phase difference plate and optical head device

(75) Inventors: Takashi Takahashi, Tokyo (JP); Nobuki Tanaka, Tokyo (JP); Takaaki Saito, Tokyo (JP)

Correspondence Address: FOLEY AND LARDNER;SUITE 500, 3000 K STREET NW, WASHINGTON, DC, 20007, US

(73) Assignee: KABUSHIKI KAISHA TOPCON

(21) Appl. No.: 11/079,014

(22) Filed: Mar. 14, 2005

(30) Foreign Application Priority Data
Mar. 23, 2004 (JP) 2004-084828
Apr. 23, 2004 (JP) 2004-128048

(51) Int. Cl. G01B 9/02

(52) U.S. Cl. 359/494; 359/485

(57) ABSTRACT

A phase difference plate is formed by bonding a fixed substrate which has a transmission function or a reflection function to at least one of surfaces of an organic thin film through an adhesive. The phase difference plate has a relation of E1≧E2>E3 wherein E1 is a linear expansion coefficient of the organic thin film, E2 is a linear expansion coefficient of the adhesive, and a linear expansion coefficient E3 of the fixed substrate. When the laser wavelength is fluctuated by temperature change, phase difference is changed so as to match to the fluctuation of wavelength. An optical head device has the phase difference plate in such a way that an arrangement position of the phase difference plate is changeable.

### TECHNICAL FIELD

The present invention relates to a phase difference plate and an optical head device. For example, the present invention relates to a phase difference plate which is used for recording and reproducing information by irradiating an optical recording medium, for example, an optical disk such as CD and DVD or a magneto optical disk with a semiconductor laser light beam, and the optical head device is provided with the phase difference plate.

### RELATED ART

Conventionally, as shown in Japanese Patent Laid-Open Publication No. 2000-310718 and Japanese Patent Laid-Open Publication No. 2003-344652, an organic thin film such as uniaxially stretched polycarbonate is used as a phase difference plate used for an optical head device.

On the other hand, when an optical head device is operated for a long time, temperature change is generated with the lapse of time inside an optical head device. When the phase difference plate is incorporated into the optical head device, an oscillation wavelength of the semiconductor laser is fluctuated by the temperature change, which does not allow a predetermined phase difference to be obtained during the passage of the laser beam through the phase difference plate.

Therefore, as shown in Japanese Patent Laid-Open Publication No. 2000-310718 for example, when the phase difference plate is used while incorporated into the optical head device, there has been proposed a phase difference plate in which the predetermined phase difference can be obtained by absorbing deformation of a phase difference film (typical example of the organic thin film) caused by an increase in temperature with an adhesive while the fluctuation in wavelength of the light beam emitted from the semiconductor laser caused by the temperature change is compensated.

When the phase difference plate is arranged in the optical head device, there is a possibility that temperature environment is changed according to a position where the phase difference plate is arranged.

When the phase difference plate is arranged at the position close to the semiconductor laser light source, the temperature environment is rapidly changed.

On the contrary, when the phase difference plate is arranged at the position away from the semiconductor laser light source, the temperature environment is slowly changed.

### SUMMARY OF THE INVENTION

An object of the invention is to provide a phase difference plate which is hardly sensitive to temperature environment of the device inside and an optical head device into which the phase difference plate is incorporated, by focusing attention on a relationship between a linear expansion coefficient of the organic thin film and a linear expansion coefficient of an adhesive.

Another object of the invention is to provide a phase difference plate which is hardly sensitive to temperature environment of the device inside without using the adhesive and the optical head device phase into which the phase difference plate is incorporated.

A phase difference plate according to the present invention is characterized in that a fixed substrate has a transmission function or a reflection function and is bonded to at least one of surfaces of an organic thin film through an adhesive, and the phase difference plate has a relation of E1≧E2≧E3 wherein E1 is a linear expansion coefficient of the organic thin film, E2 is a linear expansion coefficient of the adhesive, and E3 is a linear expansion coefficient of the fixed substrate.

A further phase difference plate according to the present invention is characterized in that an organic thin film which acts as a fixed substrate is fixed to one surface or both surfaces of one organic thin film by pressure bonding or fusion bonding.

In an optical head device according to the present invention, the above-stated a phase difference plate having such characteristics is incorporated. Preferably the phase difference plate is provided in such a way that an arrangement position of the phase difference plate can be changed.

When a laser wavelength is fluctuated due to the temperature change, the phase difference plate according to the present invention can change phase difference so that the phase difference matches to the fluctuation in wavelength.

Further, in the optical head device according to the present invention, the phase difference can be changed so as to match to the fluctuation in laser wavelength caused by the temperature change.

According to the present invention, in the phase difference plate in which the linear expansion coefficient of the organic thin film, the linear expansion coefficient of the adhesive, and the linear expansion coefficient of the fixed substrate are set to a predetermined relation or the optical head device which is equipped with such phase difference plate, usable temperatures can arbitrarily be selected so that the phase difference plate is hard to receive influence of temperature environment inside the optical head device. Therefore, a degree of freedom can be improved in design for arrangement of the phase difference plate in the optical head device.

Further, according to the present inventions in claims 2 and 4 of the application, in order to improve performance of the phase difference plate or to reduce a size of the phase difference plate, the arrangement position of the phase difference plate can be changed.

### BRIEF DESCRIPTION OF THE DRAWINGS

FIG. 1 is a sectional view showing a phase difference plate according to an embodiment of the present invention;

FIG. 2 is a sectional view showing phase a difference plate according to another embodiment of the present invention;

FIG. 3 is an explanatory view showing an example of an optical head device according to the present invention;

FIG. 4 shows one of processes of a series for producing the phase difference plate shown in FIG. 1;

FIG. 5 shows a process subsequent to the process of FIG. 4;

FIG. 6 shows a process subsequent to the process of FIG. 5;

FIG. 7 shows a process subsequent to the process of FIG. 6;

FIG. 8 shows relationships between phase difference (Re value) and temperature change of three types of phase difference plates, particularly a change in Re value at 650 nm;

FIG. 9 shows the relationships between the phase difference (Re value) and the temperature change of the three types of phase difference plates, particularly the change in Re value at 780 nm;

FIG. 10 shows the relationships between the phase difference (Re value) and the temperature change of the three types of phase difference plates, particularly the amount of change at 650 nm; and

FIG. 11 shows the relationships between the phase difference (Re value) and the temperature change of the three types of phase difference plates, particularly the amount of change at 780 nm.

### EMBODIMENTS

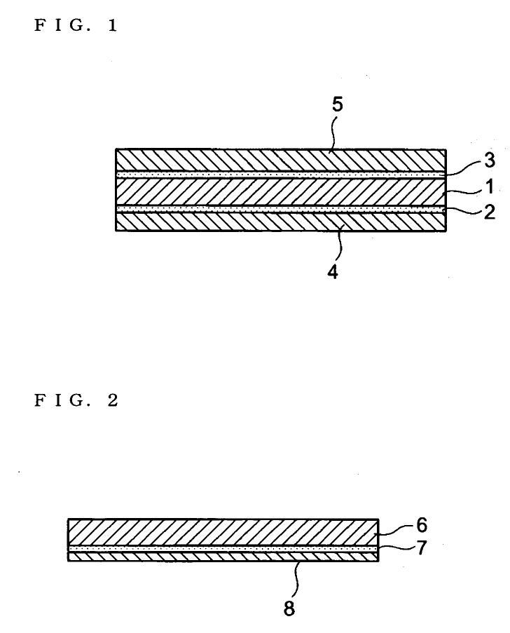

FIG. 1 shows a phase difference plate, in which adhesives 2 and 3 are applied to both surfaces of an organic thin film 1, and two fixed substrates 4 and 5 are bonded so as to sandwich the organic thin film 1 from both sides through the adhesives 2 and 3.

In the embodiment shown in FIG. 1, a thickness of the organic thin film 1 ranges preferably from 0.2 to 1.0 mm, thicknesses of the adhesive 2 and 3 range preferably from 5 to 20 μm, and thicknesses of the fixed substrates 4 and 5 range preferably from 0.2 to 2.0 mm.

FIG. 2 shows another phase difference plate, in which an adhesive 7 is applied to one of surfaces of an organic thin film 6, and one fixed substrate 8 is stuck onto the surface to which the adhesive 7 is applied.

In the embodiment shown in FIG. 2, the thickness of the organic thin film 6 ranges preferably from 0.2 to 1.0 mm, the thickness of the adhesive 7 ranges preferably from 5 to 20 μm, and the thickness of the fixed substrate 8 ranges preferably from 0.2 to 2.0 mm.

Although it is preferable that the fixed substrate 4, 5, and 8 shown in FIGS. 1 and 2 are made of a glass plate, it is also possible that the fixed substrate 4, 5, and 8 are made of other materials, e.g. a plastic plate or the organic thin film such as a cycloolefin polymer and polycarbonate.

Although it is not shown in the drawings, when the fixed substrate is formed out of the organic thin film, it is possible that the fixed substrate and the phase difference film are fixed to each other by pressure bonding or fusion bonding without using any adhesive. After the pressure bonding or the fusion bonding, the fixed substrate and the phase difference film have a structure in which the adhesive is omitted from the configurations shown in FIGS. 1 and 2. In this case, it is preferable that the thickness of the organic thin film constituting the fixed substrate ranges from 0.2 to 1.0 mm, and it is preferable that the thickness of the organic thin film constituting the phase difference film ranges from 0.2 to 1.0 mm.

In the embodiments shown in FIGS. 1 and 2, examples of the phase difference film used as the organic films 1 and 6 include cycloolefin polymer and polycarbonate such as ARTON (registered trademark, the product of JSR Corporation), APEL (registered trademark, the product of Mitsui Chemicals), and ZEONEX (registered trademark, the product of ZEON Corporation).

The linear expansion coefficients E1, E2, and E3 are formed so as to satisfy the relation of E1≧E2≧E3, wherein E1 are the linear expansion coefficients of the organic thin films 1 and 6, E2 are the linear expansion coefficients of the adhesives 2, 3, and 7, and E3 are the linear expansion coefficients of the fixed substrates 4, 5, and 8 are E3.

The adhesives 2, 3, and 7 having such particular relation are produced, and the fixed substrates 4, 5, and 8 and the organic thin films 1 and 6 are stuck to each other with the special adhesives 2, 3, and 7. The adhesives 2, 3, and 7 can also be used together with a primer.

A specific example will be described below.

The phase difference film is used as the organic thin films 1 and 6. In the phase difference film, it is assumed that a glass transition temperature is not more than 130° C. and the linear expansion coefficient E1 ranges from 7.0 to 9.0×10⁻⁵/° C. Normally the glass transition temperatures of the adhesives 2, 3, and 7 are about 80° C. In the case where the glass transition temperatures of the adhesives 2, 3, and 7 are not more than 80° C. (usually 40° C. to 50° C.), it is preferable that the linear expansion coefficients E2 of the adhesives 2, 3, and 7 are α×10⁻⁵/° C., where a ranges from 4.9 to 6.1. The linear expansion coefficients E3 of the glass-made fixed substrates 4, 5, and 8 are 95×10⁻⁷/° C. In this specific example, the relation of E1≧E2≧E3 is satisfied.

Because the linear expansion coefficients E3 of the fixed substrates 4, 5, and 8 made of the plastic such as polycarbonate are 7.0×10⁻⁵/° C., the following relation can be satisfied:
E1≧E3

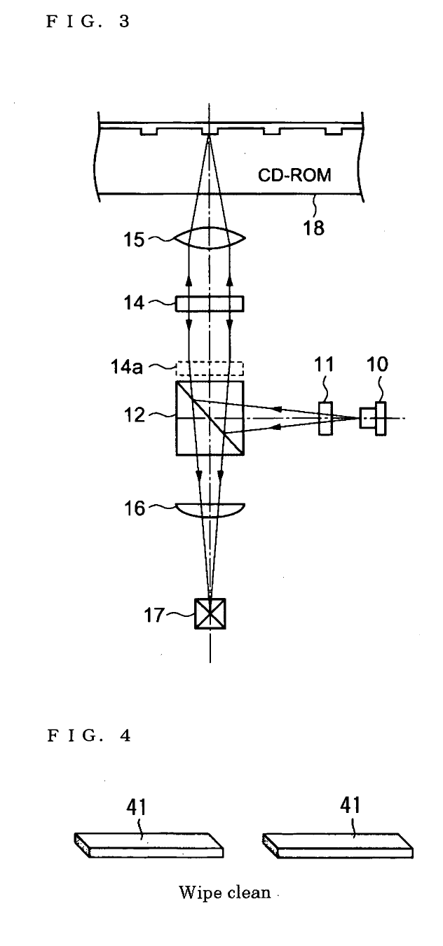

FIG. 3 shows an example of the optical head device.

The optical head device includes a laser diode 10 (light source) which is of the semiconductor laser, a diffraction grating 11, a polarization beam splitter 12, a collimator lens (not shown), a phase difference plate 14, an objective lens 15, a cylindrical lens 16, and a photodetector 17.

In the optical head device, an arrangement position of the phase difference plate 14 can be changed along an optical axis between a position shown by a solid line and a position (14a) shown by a broken line.

The laser beam emitted from the laser diode 10 is diffracted by the diffraction grating 11 and reflected from the polarization beam splitter 12 toward CD-ROM 18 (or DVD).

In the laser beam reflected by the polarization beam splitter 12, the phase with a predetermined wavelength (λ/4 or λ/2) is changed by the phase difference plate 14, and CD-ROM 18 (or DVD) is irradiated with the laser beam via the objective lens 15. The laser beam reflected from CD-ROM 18 (or DVD) is detected by the photodetector 17.

Thus, the information in CD-ROM 18 (or DVD) which is of the information storage medium is reproduced and recorded.

It is preferable that the light beam emitted from the laser diode 10 is a blue laser.

The optical head device shown in FIG. 3 includes the phase difference plate according to the present invention. The wavelengths used in the optical head device are preferably λ1=655±20 nm and λ2=785±20 nm. Also, the wavelength with λ3=405±10 nm can be used.

Referring to FIGS. 4 to 7, an example of a method of producing the phase difference plate shown in FIG. 1 will be described below.

For the phase difference film formed out of the organic thin film, the commercially available phase difference film can be used by cutting the phase difference film in the predetermined size.

For the adhesive, it is preferable to use the ultraviolet curing adhesive.

For the fixed substrate, it is preferable to use the fixed substrate in which an AR coat satisfying specifications is applied to one of surfaces.

It is preferable that the glass plate used as the fixed substrate is formed in the size of 76 mm×76 mm×0.97 (thickness) mm. Also, the thickness of 0.2 mm can be used.

It is preferable that a phase difference film 43 (FIG. 6) used as the organic thin film 1 of FIG. 1 is formed so as to fit the size of the glass-made fixed substrate.

The phase difference film 43 and the glass-made fixed substrate 41 are bonded to each other by the following steps (a) to (d).

(a) As shown in FIG. 4, a bonding surface (opposite surface to the AR coated surface) of the glass-made fixed substrate 41 with the AR coat is wiped up well.

The one glass-made fixed substrate 41 with the AR coat is used in the embodiment shown in FIG. 2, while the two glass-made fixed substrates 41 with the AR coat are used in the embodiment shown in FIG. 1.

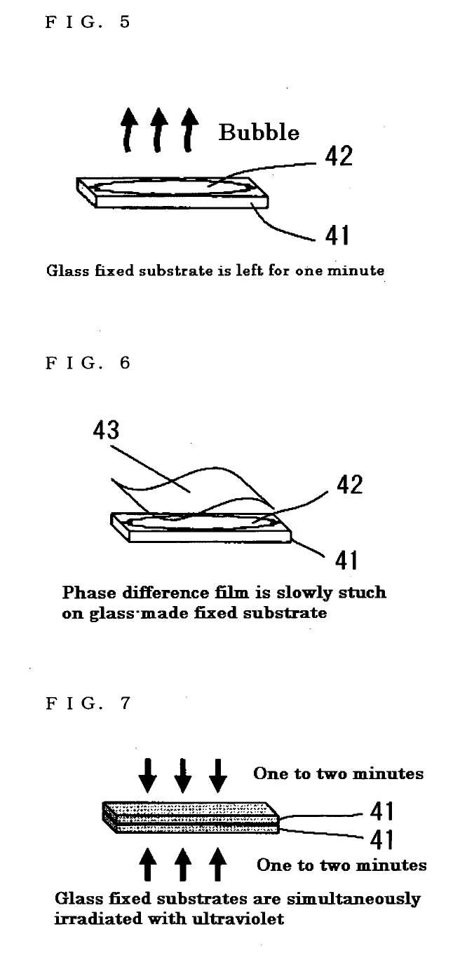

(b) As shown in FIG. 5, the adhesive 42 of about 1.0 g is evenly applied to the surface on which the AR coat is not deposited in the glass-made fixed substrate 41. In spreading the adhesive 42 on the surface, the adhesive 42 is spread so that bubbles are not generated in the adhesive 42 to the utmost. After spreading the adhesive 42, the surface to which the adhesive 42 is applied is left for about one minute so that the bubbles escape from the adhesive 42.

(c) As shown in FIG. 6, a protective sheet (not shown) on one side of the surfaces of the phase difference film 43 is peeled off. Then, while an end of the phase difference film 43 is aligned with the end of the glass-made fixed substrate 41 (phase difference axis alignment), the phase difference film 43 and the glass-made fixed substrate 41 are slowly bonded to each other from the ends with care so that the bubble does not enter the bonding surface.

(d) When the bonding of phase difference film 43 to one of the surfaces of the glass-made fixed substrate 41 is ended, as with the processes (a) to (c) above-mentioned, the bonding surface of the other glass fixed substrate 41 is bonded to the other surface of the phase difference film 43.

After the two glass-made fixed substrates 41 and the phase difference film 43 are bonded while the phase difference film 43 is sandwiched between the two glass-made fixed substrates 41, the thickness of the layer of the adhesive 42 is made uniform by pressing the both surfaces of the glass-made fixed substrates 41 with pressure of about 5 to 10 kg/cm².

Thus, the bonding steps are completed.

Then, the adhesives 42 applied to the surfaces of the glass fixed substrate 41 are cured by irradiating them with an ultraviolet ray in the following processes (e) and (f). At this point, luminance of the ultraviolet ray is set to the range from 10 to 50 mW/cm² (at 365 nm). A high-pressure mercury lamp (the product of USHIO INC.) can be used as an irradiating device.

(e) As shown in FIG. 7, both surfaces of the glass-made fixed substrate 41 are simultaneously irradiated with the ultraviolet ray for one to two minutes while the phase difference film 43 is sandwiched between the two glass-made fixed substrates 41.

(f) The surfaces of the outsides of the two glass-made fixed substrates 41 are wiped clean using acetone.

Thus, the two glass-made fixed substrates 41 are bonded to both surfaces of the phase difference film 43, while sandwiching the phase difference film 43 is ended.

Then, the phase difference film 43 with the two glass-made fixed substrates 41 is cut in the predetermined size as occasion demands and washed to obtain the desired phase difference plate.

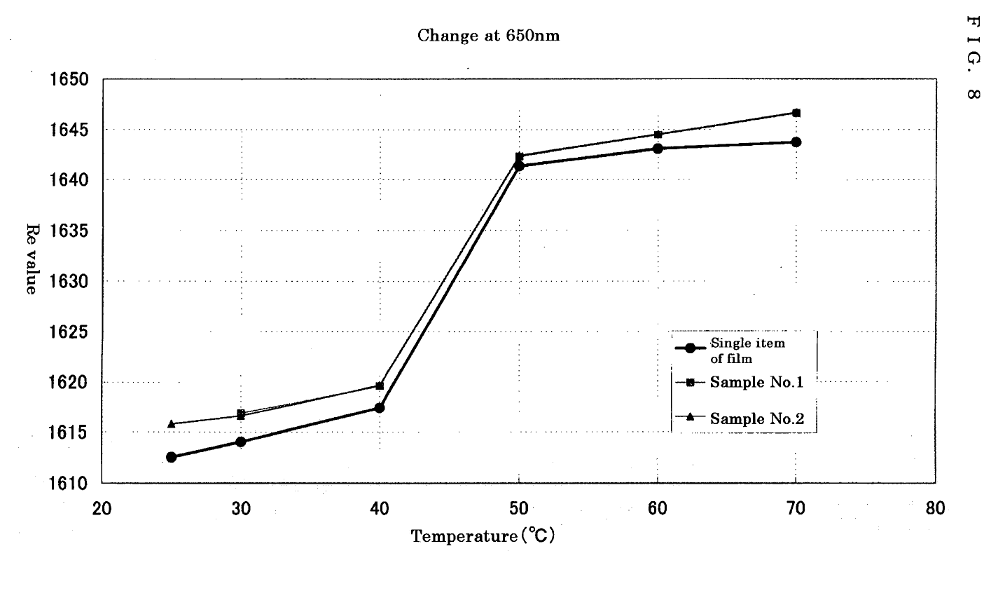

Referring to FIGS. 8 to 11, a relationship between the phase difference (Re value, i.e. retardation value) and the temperature change.

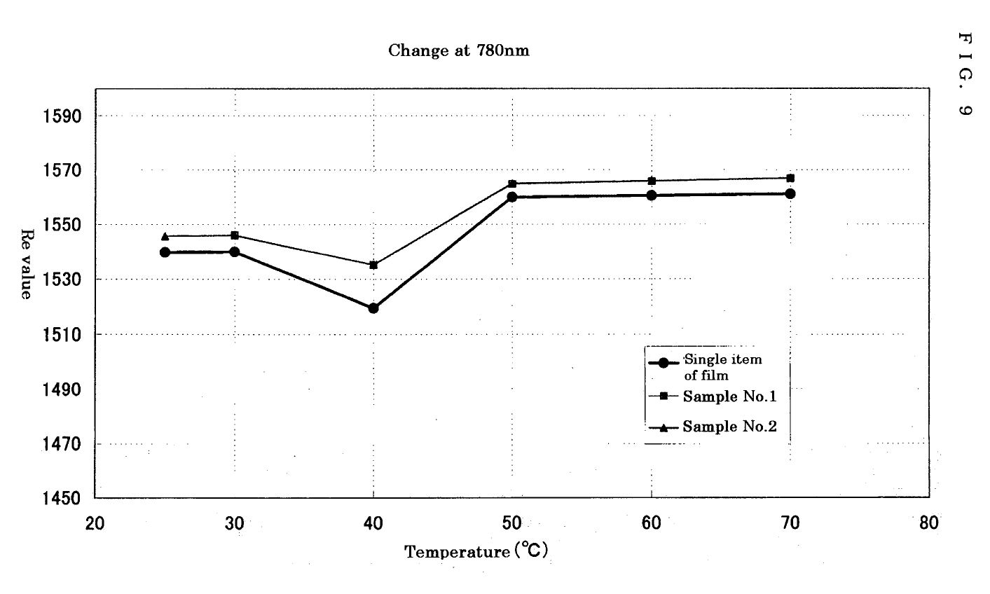

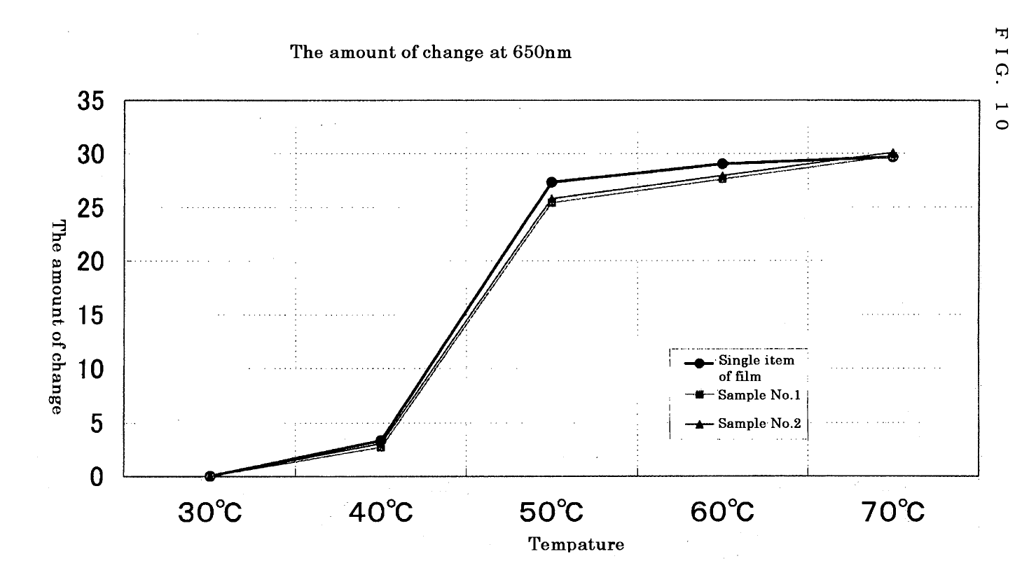

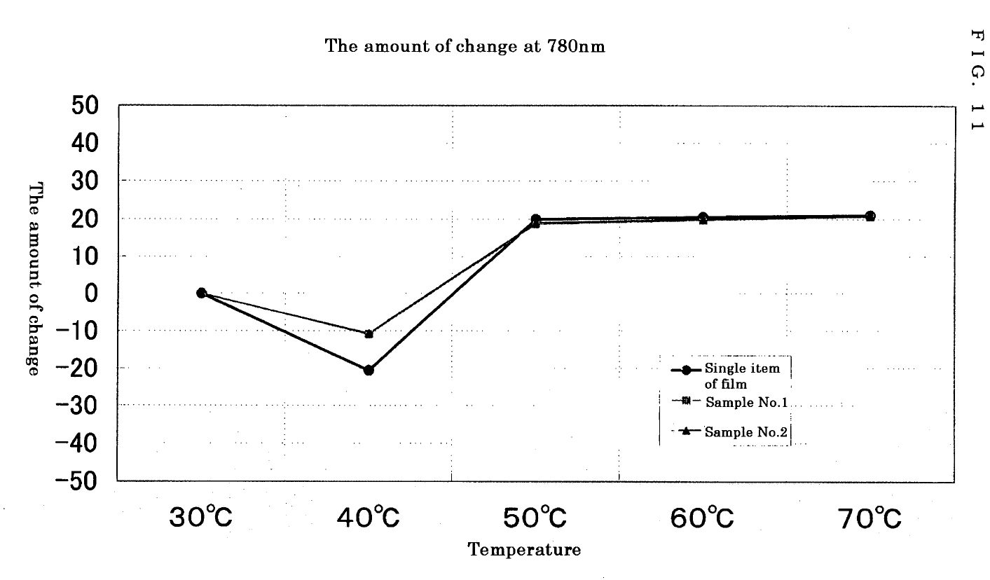

FIG. 8 shows the change in Re value at 650 nm, and FIG. 9 shows the change in Re value at 780 nm. FIG. 10 shows the amount of change at 650 nm, and FIG. 11 shows the amount of change at 780 nm.

FIG. 8 shows the relationships between phase difference (Re value, i.e. a retardation value) and temperature change of the three types of phase difference plates, i.e. a single item of the film, a sample No. 1, and a sample No. 2.

Namely, FIGS. 8 to 11 show the graph in the case where the single item of the phase difference film formed out of the organic thin film is used, the graph in the case of the use of the phase difference plate (sample No. 1) in which the two glass-made fixed substrates are stuck to the phase difference film using the adhesive while sandwiching the phase difference film there between, and the graph in the case of the use of the phase difference plate (sample No. 2) in which the one glass-made fixed substrate is stuck to the phase difference film with the adhesive.

The sample No. 1 has the structure shown in FIG. 1, the sample No. 2 has the structure shown in FIG. 2, and the single item of the phase difference film is not shown.

As can be seen from FIGS. 8 to 11, the single item of the phase difference film is similar to the phase difference plates in which the glass-made fixed substrates is stuck to the phase difference film using the adhesive as shown in FIGS. 1 and 2 in the change of retardation value (Re value). Particularly, even if the temperature is about 80° C., the changes in retardation values are similar to one another. Accordingly, even if the environment temperature in the optical head device becomes higher temperature than an ordinary temperature, the phase difference plate is never affected by the temperature change caused by the laser beam.

Even if the phase difference plate is moved between the position 14 shown by the solid line in FIG. 3 and the position 14a shown by the broken line in FIG. 3, i.e. even if the phase difference plate 14 is arranged by moving the phase difference plate 14 to an arbitrary position located between the position close to the laser light source (laser diode 10) in the optical head device and another position far away from the position, the phase difference plate 14 is not affected by the temperature change caused by the laser beam. Therefore, a degree of freedom is increased in design with respect to the arrangement of the phase difference plate in the optical head device. Consequently, applicability of the phase difference plate to the optical head devices of various types can be enlarged.

1. A phase difference plate comprising an organic thin film having surfaces and a fixed substrate which has a transmission function or a reflection function and is bonded to at least one of the surfaces of the organic thin film through an adhesive, the phase difference plate having a relation of E1≧E2≧E3 wherein E1 is a linear expansion coefficient of the organic thin film, E2 is a linear expansion coefficient of the adhesive, and E3 is a linear expansion coefficient of the fixed substrate.

2. An optical head device wherein the phase difference plate defined in claim 1 is formed so as to be changeable along an optical axis.

3. A phase difference plate comprising a first organic thin film which functions as a fixed substrate is fixed to one surface or both surfaces of a second organic thin film by pressure bonding or fusion bonding.

4. An optical head device wherein the phase difference plate defined in claim 3 is formed so as to be changeable along an optical axis.
